(19) United States
(12) Patent Application Publication
(10) Pub. No.: US 2012/0265879 A1
(43) Pub. Date: Oct. 18, 2012

(54) MANAGING SERVICABILITY OF CLOUD COMPUTING RESOURCES

(75) Inventors: Jason Richard Casebolt, Redmond, WA (US); Vikas Ahuja, Sammamish, WA (US); Bryan P. Sera, Seattle, WA (US); David James Lee, Redmond, WA (US); Suresh Tharamal, Sammamish, WA (US)

(73) Assignee: MICROSOFT CORPORATION, Redmond, WA (US)

(21) Appl. No.: 13/088,025

(22) Filed: Apr. 15, 2011

(51) Int. Cl. G06F 15/173

(52) U.S. Cl. 709/225

(57) ABSTRACT

The management of serviceability in a cloud of computing resources. The computing resources available in the cloud are represented for access control purposes as a hierarchy of nodes. Upon receiving a request to perform an action on a computing resource, the associated hierarchical node that controls the action with respect to the requestor is identified. Then, the associated access privilege of that hierarchical node is identified. In some embodiments, if it is determined that the requestor has rights to perform the action on the computing resource, the action is facilitated.

### BACKGROUND

There are a variety of aspects involved with servicing software. For instance, the software itself is deployed, upgraded, maintained, configured, and inspected. Furthermore, access to the corresponding data is facilitated.

Originally, computers were not networked. In that case, the servicing of software involved interaction with each computer. For instance, to service software, a floppy disk would be inserted into a floppy drive to facilitate the installation, or possible configuration of the software. Further, physical interaction with the computer upon which the software is installed may allow for configuration of the software, inspection of the software, or the like. The data was physical present on the computing system, and so access to the data might typically be password protected if the data was sensitive, and would be limited to those having physical access to the computing system.

Computing systems are now highly networked. Software is often remotely serviced. For instance, information technology specialists may install or upgrade software to many computing systems from a centralized control location. Likewise, software may be maintained, configured, and inspected at least partially from that centralized control location.

Computing resources are now often “cloud-based”. That is, the actual physical computing systems that runs the application and/or stores data are abstracted away from the customer. The client machine has middleware running on the client that interfaces with application(s) running in the cloud on computing nodes. The providers of such cloud-based computing nodes typically set up a multiple machines in the form of computers, servers, and data storage systems. Each computer may run thereon one or more virtual computing resources, referred to as computing nodes.

### BRIEF SUMMARY

At least one embodiment described herein relates to the management of serviceability in cloud computing resources. The computing resources available in the cloud are represented for access control purposes as a hierarchy of nodes. Upon receiving a request to perform an action on a computing resource, the associated hierarchical node that controls the action with respect to the requestor is identified. Then, the associated access privilege of that hierarchical node is identified. In some embodiments, if it is determined that the requestor has rights to perform the action on the computing resource, the action is facilitated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a cloud computing environment that includes a client interfacing with a cloud of computing resources over a network;

FIG. 3 illustrates an example hierarchical node structure that includes a root node and multiple other tiers of nodes;

FIG. 4 illustrates a flowchart of a method for managing serviceability of cloud computing resources; and

FIG. 5 illustrates a flowchart of a method for auditing actions performed in cloud computing resources.

### DETAILED DESCRIPTION

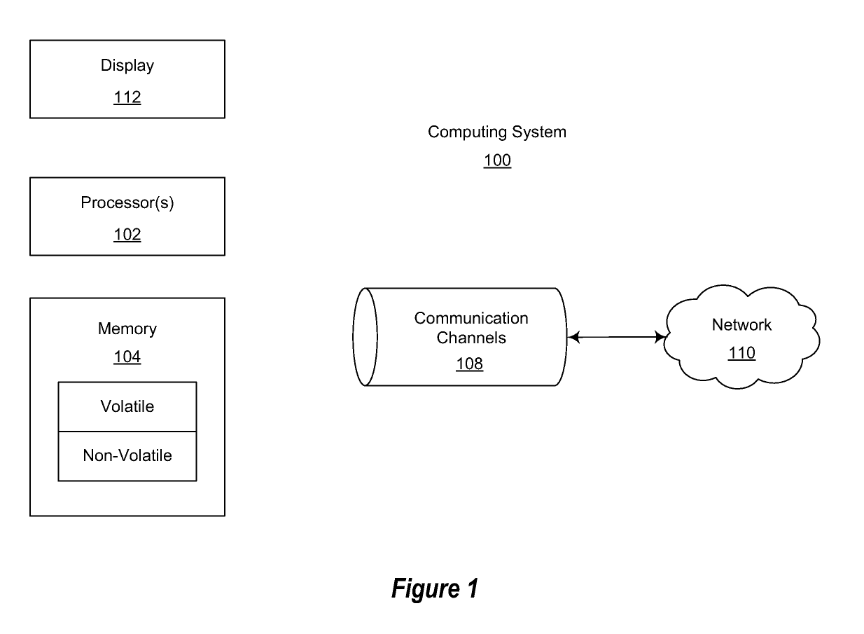

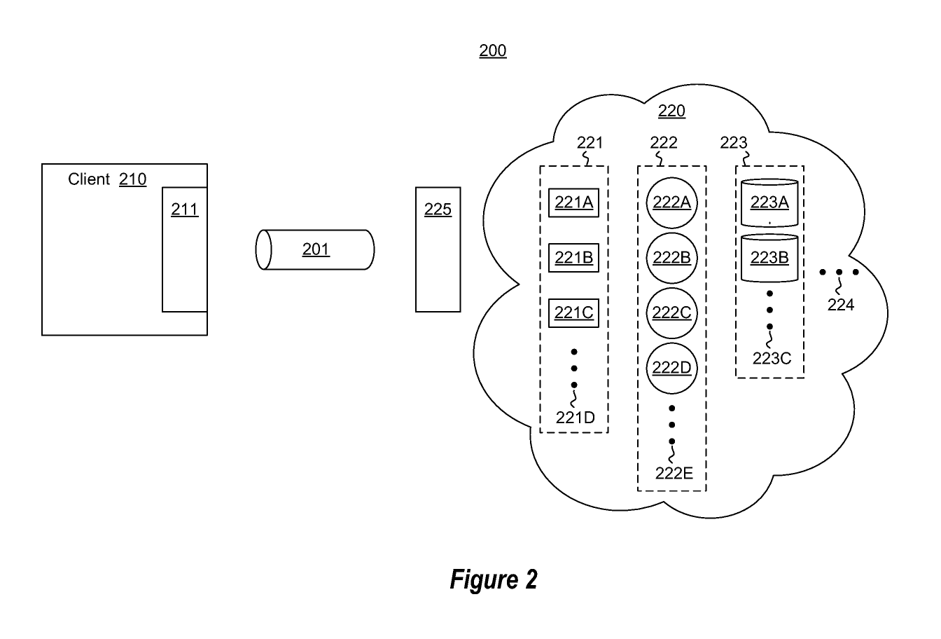

In accordance with embodiments described herein, the management of serviceability in cloud computing resources is described. The computing resources available in the cloud are represented for access control purposes as a hierarchy of nodes. Upon receiving a request to perform an action on a computing resource, the associated hierarchical node that controls the action with respect to the requestor is identified. Then, the associated access privilege of that hierarchical node is identified. In some embodiments, if it is determined that the requestor has rights to perform the action on the computing resource, the action is facilitated. First, some introductory discussion regarding computing systems will be described with respect to FIG. 1. Then, the embodiments of managing serviceability in the cloud computing resources will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems. As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system may also include a display 112 that may display one or more user interfaces that a user of the computing system may interface with.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a cloud computing environment 200 that includes a client 210 interfacing with a cloud 220 of computing resources over a network 201. The client 210 may, for example, be structured like the computing system 100 of FIG. 1. The client 210 includes an interface 211 that interfaces with computing resources on the cloud 220 such that the computing resources can be utilized by the client without having to be maintained on the client itself. Such offloaded computing resources may include data storage, application(s), processing resources, and the like. The cloud may serve a number of clients though only one client 210 is illustrated in FIG. 2.

The cloud 220 is termed a “cloud” because from the viewpoint of the client, the actual hardware used to provide the computing resources is abstracted away. That hardware may include computing systems and/or storage resources. In grid computing, the cloud may include large collections of interconnected computing systems, perhaps some of which cooperatively interacting to provide a computing resource.

As an example only, the cloud 220 is illustrated as including computing resources in the form of software 221, processing resources 222, and data storage 223, though the ellipses 224 represents that the cloud 220 may have other types of computing resources as well. The software 221, which may be applications, components, modules, or any other software, is illustrated as including software 221A, 221B and 221C, though ellipses 221D represents that the cloud 220 may include any number of software resources. The processing resources 222, which may include processing core(s), computing system(s) or combinations there, is illustrated as including processing resources 222A, 222B, 222C and 222D, although the ellipses 222E represents that the cloud 220 may include any number of processing resources. The data storage 223, which may include disk drives, storage capacity, or the like, is illustrated as including data storage resources 223A and 223B, although the ellipses 223C represents that the cloud 220 may include any number of storage resources.

The cloud 220 also includes an access control component 225 that communicates with the client interface 211 for purposes of providing access to the computing resources as requested by the client 210. The access control component 225 may be, for example, a single software component, or a combination of software components, and may be located on a single computing system, or distributed across multiple computing systems. The access control component 225 is configured to manage the serviceability of the cloud computing resources. The access control component 225 may be situated in the cloud 220, in front of the cloud 220, and/or in the client 210.

The access control component 225 may be implemented by the processor(s) of a computing system executing one or more computer-executable instructions provided on one or more computer-readable media as part of a computer program product. The access control component 225 may perform the methods described herein also in response to executing such computer-executable instructions.

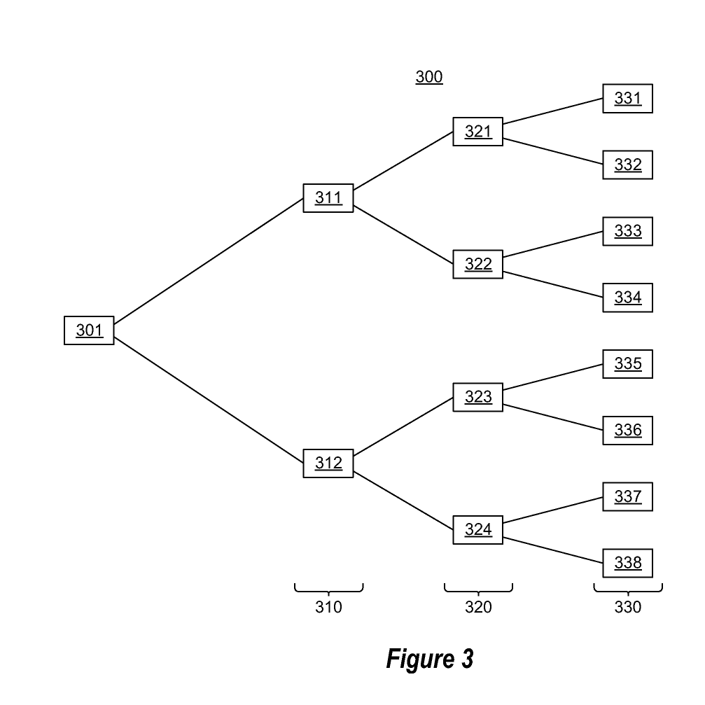

FIG. 3 illustrates an example hierarchical node structure 300 that includes a root node 301 and multiple other tiers of nodes. The hierarchical node structure may be any structure. However, in the example hierarchical structure, there are three additional tiers 310, 320 and 330. In this example, each non-leaf node has three child nodes. Each node represents one of more computing resources available in the cloud 220.

There may be any relationship between parent and child nodes. However, in the example described herein, the computing resources of each child node is also included within the parent node, and access privileges defined for the parent node are at least conditionally inherited by the child node and through the descendent chain. For instance, one condition might be that there is not an access privilege of the child node that contradicts the access privilege of the parent node. As an example, if a certain access privilege is defined for the node 311, that access privilege may be applied to all of descendent nodes 321, 322, and 331 through 334, unless specifically contradicted. Likewise, if a certain access privilege is defined for the node 312, that access privilege may be applied to all of descendent nodes 323, 324, and 335 through 338, unless specifically contradicted further down the descendant chain.

In one example, the first-tier nodes 311 and 312 each represent environment types. For instance, as an example only, node 311 might represent production data center environment types, whereas node 312 might represent testing data center environment types. The second-tier nodes 320 might each represent specific environments. For instance, node 321 might represent a production data center that is located in Asia, whereas node 322 might represent a production data center that is located in North America. Likewise, node 323 might represent a testing data center that is located in South America, whereas node 324 might represent a testing data center that is located in Europe. The third-tier nodes 330 might represent data storage networks that are available within each corresponding data center represented in the second-tier 320.

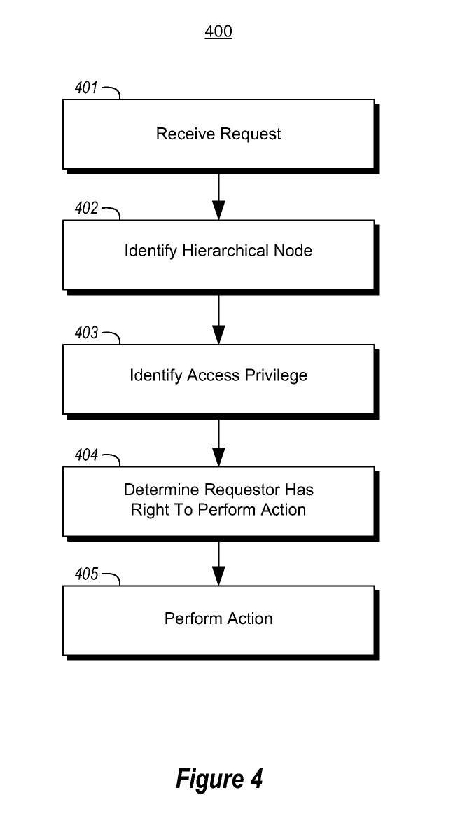

FIG. 4 illustrates a flowchart of a method 400 for managing serviceability of cloud computing resources, and may be performed by, for example, the access control component 225 of FIG. 2. The method 400 may be performed for each of at least some of the requests received the access control component, and may be performed for requests received from any of multiple clients.

For each request for which the method 400 is to be performed, the access control component 225 receives the request (act 401). The request is to perform some action on a target computing resource within the cloud 220 of computing resources. The action could be to install software in the cloud 220. For instance, the action may be to upload software to a computing resource, deploy software to the computing resource, and/or start software on the target computing resource or the like. The action might also be to inspect software performance on the target computing resource, configure software on the target computing resource, upgrade software on the target computing resource, or the like.

Once the request is accessed, the corresponding hierarchical node that controls access to the target computing resource is identified (act 402). For instance, suppose the action is to upgrade software in the testing data center hypothetically located in South America in the prior example. In that case, the target computing resource is the South America testing data center, and the corresponding hierarchical node in the hierarchical tree 300 would hypothetically be node 323.

The access privilege associated with the hierarchical node is then identified (act 403), especially with respect to the requested action. For instance, in the example, the request is to upgrade software on that target computing resource corresponding to hierarchical node 323. If, for example, node 323 was not specific as to upgrade rights, then perhaps nodes in the ancestral chain (e.g., node 312, or even root node 301) may be referred to to derive the upgrade rights of the requestor with respect to the target computing resource. For instance, root node 301 may define default rights that apply unless specifically overridden by another node that is more specific to the target computing resource.

If the requestor does not have rights to perform the requested action on the target computing resource, then perhaps appropriate action would be taken such as, for example, notifying the requestor that the request is denied and/or preventing the request from being honored. On the other hand, if it is determined that the requestor does have the rights to perform the requested action (act 404) based on the identified access privilege, then the requested action may optionally be honored (act 405).

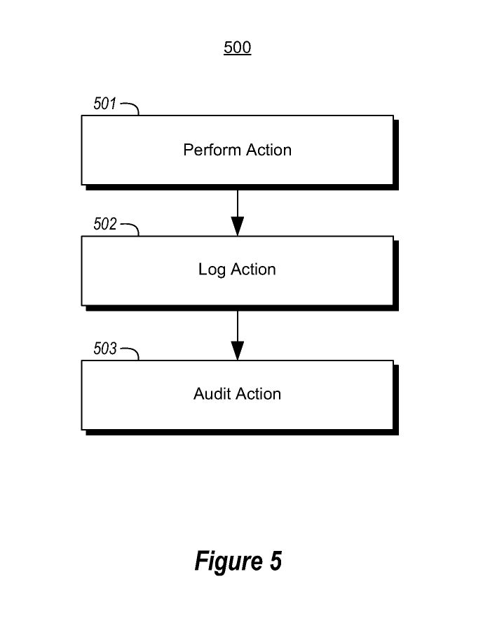

FIG. 5 illustrates a flowchart of a method for auditing actions performed in cloud computing resources. Upon performing the requested action (act 501, which may be the same as act 405), the action and the requestor combination may be logged (act 502) as well as whether the action was successful or failed. The log may be a cumulative record of multiple actions by multiple requestors with respect to the corresponding computing resources. This log may then be audited (act 503) at any point in the future to determine when and who attempted which actions with respect to computing resources and whether the attempt was successful or a failure. Read access to the audit log itself may be governed by the access control component 225.

Accordingly, an effective mechanism for controlling access to computing resources in a cloud and otherwise managing serviceability in the cloud are described. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer storage media having thereon computer-executable instructions that are structured such that, when executed by one or more processors of a computing system, cause the computing system to perform a method for managing serviceability of cloud computing resources, the method comprising:
an act of receiving a request to perform an action on a computing resource within a cloud of computing resources;
an act of identifying a hierarchical node controlling access to the computing resource, wherein cloud computing resources is represented as a hierarchy of nodes in which each node represents a set of one or more computing resources, and in which access privileges are defined on each of at least some of the nodes in the hierarchy, wherein for at least one of the nodes in which an access privilege is defined, that access privilege is inherited by at least one descendent node in the hierarchy of nodes;
an act of identifying an access privilege corresponding to the hierarchical node; and
an act of determining that the requestor of the action has rights to perform the action on the computing resource based on the identified access privilege.

2. The computer program product in accordance with claim 1, wherein the one or more computer-executable instructions that are further structured such that, when executed by one or more processors of a computing system, further cause the computing system to perform the following:
an act of performing the requested action.

3. The computer program product in accordance with claim 1, wherein the requested action comprises uploading software to the computing resource.

4. The computer program product in accordance with claim 1, wherein the requested action comprises deploying software to the computing resource.

5. The computer program product in accordance with claim 1, wherein the requested action comprises starting software to the computing resource.

6. The computer program product in accordance with claim 1, wherein the requested action comprises inspecting software performance on the computing resource.

7. The computer program product in accordance with claim 1, wherein the requested action comprises configuring software on a computing resource.

8. The computer program product in accordance with claim 1, wherein the requested action comprises upgrading software on the computing resource.

9. The computer program product in accordance with claim 1, wherein the hierarchy of nodes includes environment type nodes.

10. The computer program product in accordance with claim 9, wherein the hierarchy of nodes includes environment nodes that are descendent nodes of environmental type nodes.

11. The computer program product in accordance with claim 10, wherein the hierarchy of nodes includes application nodes that are descendent nodes of environmental nodes.

12. The computer program product in accordance with claim 9, wherein the hierarchy of nodes includes application nodes that are descendent nodes of environmental type nodes.

13. The computer program product in accordance with claim 1, wherein the hierarchy of nodes includes application nodes.

14. The computer program product in accordance with claim 1, wherein the one or more computer-executable instructions that are further structured such that, when executed by one or more processors of a computing system, further cause the computing system to perform the following:
an act of logging the requested action in a log.

15. The computer program product in accordance with claim 1, wherein the one or more computer-executable instructions that are further structured such that, when executed by one or more processors of a computing system, further cause the computing system to perform the following:
an act of auditing the requested action using the log.

16. A method for managing serviceability of cloud computing resources, the method comprising:
an act of a server, having one or more processors, receiving a request to perform an action on a computing resource within a cloud of computing resources;
an act of the server identifying a hierarchical node controlling access to the computing resource with respect to the requested access and the requestor, wherein cloud computing resources is represented as a hierarchy of nodes in which each node represents a set of one or more computing resources; and
an act of the server identifying an access privilege corresponding to the hierarchical node.

17. The method in accordance with claim 16, further comprising:
an act of the server determining that the requestor of the action has rights to perform the action on the computing resource based on the identified access privilege.

18. The method in accordance with claim 16, further comprising:
an act of performing the requested action.

19. The method in accordance with claim 16, wherein the requested action comprises uploading software to the computing resource.

20. A computer program product comprising one or more computer storage media having thereon computer-executable instructions that are structured such that, when executed by one or more processors of a computing system, cause the computing system to perform a method for managing serviceability of cloud computing resources, the method comprising:
an act of receiving a request to install software within a cloud of computing resources;
an act of identifying a hierarchical node controlling access to the target of installation, wherein cloud computing resources is represented as a hierarchy of nodes in which each node represents a set of one or more computing resources, and in which access privileges are defined on each of at least some of the nodes in the hierarchy, wherein for at least one of the nodes in which an access privilege is defined, that access privilege is inherited by at least one descendent node in the hierarchy of nodes;
an act of identifying an access privilege corresponding to the hierarchical node;
an act of determining that the requestor of the action has rights to perform the action on the computing resource based on the identified access privilege; and
an act of performing the requested action.
